(19) United States
(12) Patent Application Publication
(10) Pub. No.: US 2004/0115119 A1
(43) Pub. Date: Jun. 17, 2004

(54) Preparation of chlorine by gas-phase oxidation of hydrogen chloride

(75) Inventors: Gerhard Olbert, Dossenheim (DE); Christian Walsdorff, Ludwigshafen (DE); Klaus Harth, Altleiningen (DE); Eckhard Strofer, Mannheim (DE); Martin Fiene, Niederkirchen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/323,628

(22) Filed: Dec. 20, 2002

(30) Foreign Application Priority Data
Dec. 12, 2002 (DE) 10258180.0

(51) Int. Cl. C01B 7/04

(52) U.S. Cl. 423/502

(57) ABSTRACT

A process for preparing chlorine by gas-phase oxidation of hydrogen chloride by means of a gas stream comprising molecular oxygen in the presence of a fixed-bed catalyst, which is carried out in a reactor (1) having a bundle of parallel catalyst tubes (2) which are aligned in the longitudinal direction of the reactor and are fixed at their ends into tube plates (3), with a cap (4) at each end of the reactor (1) and with one or more annular deflection plates (6) which are arranged perpendicular to the longitudinal direction of the reactor in the intermediate space (5) between the catalyst tubes (2) and leave circular passages (8) free in the middle of the reactor and one or more disk-shaped deflection plates (7) which leave annular passages (9) free at the edge of the reactor, with an alternating arrangement of annular deflection plates (6) and disk-shaped deflection plates (7) with the catalyst tubes (2) being charged with the fixed-bed catalyst, the hydrogen chloride and the gas stream comprising molecular oxygen being passed from one end of the reactor via a cap (4) through the catalyst tubes (2) and the gaseous reaction mixture being taken off from the opposite end of the reactor via the second cap (4) and a liquid heat transfer medium being passed through the intermediate space (5) around the catalyst tubes (2), is proposed.

The present invention relates to a process for preparing chlorine by gas-phase oxidation of hydrogen chloride in the presence of a fixed-bed catalyst.

The process developed by Deacon in 1868 for the catalytic oxidation of hydrogen chloride by means of oxygen in an exothermic equilibrium reaction represents the beginning of industrial chlorine chemistry. The Deacon process has been pushed very much into the background by chloralkali electrolysis; virtually all the chlorine produced is now obtained by electrolysis of aqueous sodium chloride solutions.

However, the Deacon process has recently been becoming more attractive again, since the world demand for chlorine is growing more quickly than the demand for sodium hydroxide. The process for preparing chlorine by oxidation of hydrogen chloride is in tune with this development since it is decoupled from sodium hydroxide production. Furthermore, hydrogen chloride is obtained in large quantities as coproduct in, for example, phosgenation reactions, for instance in isocyanate production. The hydrogen chloride formed in isocyanate production is mostly used in the oxychlorination of ethylene to 1,2-dichloroethane, which is further processed to vinyl chloride and then to PVC. Examples of the further processes in which hydrogen chloride is formed are the preparation of vinyl chloride, the preparation of polycarbonate or PVC recycling.

The oxidation of hydrogen chloride to chlorine is an equilibrium reaction. The position of the equilibrium shifts away from the desired end product as the temperature increases. It is therefore advantageous to use catalysts having a very high activity which allow the reaction to proceed at lower temperature. Such catalysts are, in particular, catalysts based on ruthenium, for example the supported catalysts which are described in DE-A 197 48 299 and comprise ruthenium oxide or a mixed ruthenium oxide as active composition. The ruthenium oxide content of these catalysts is from 0.1 to 20% by weight and the mean particle diameter of ruthenium oxide is from 1.0 to 10.0 nm. Further supportive catalysts based on ruthenium are known from DE-A 197 34 412: ruthenium chloride catalysts which further comprise at least one of the compounds titanium oxide and zirconium oxide, ruthenium-carbonyl complexes, ruthenium salts of inorganic acids, ruthenium-nitrosyl complexes, ruthenium amine complexes, ruthenium complexes of organic amines or ruthenium-acetylacetonate complexes.

A known technical problem in gas-phase oxidations, here the oxidation of hydrogen chloride to chlorine, is the formation of hot spots, i.e. regions of local overheating which can lead to destruction of the catalyst and the catalyst tube material. To reduce or prevent the formation of hot spots, WO 01/60743 has therefore proposed using catalyst charges which have different activities in different regions of the catalyst tubes, i.e. catalysts having an activity matched to the temperature profile of the reaction. A similar result is said to be achieved by targeted dilution of the catalyst bed with inert material.

Disadvantages of these solutions are that two or more catalyst systems have to be developed and used in the catalyst tubes and that the use of inert material reduces the reactor capacity.

It is an object of the present invention to provide a process for preparing chlorine on an industrial scale by gas-phase oxidation of hydrogen chloride using a gas stream comprising molecular oxygen in the presence of a fixed-bed reactor, which process ensures effective removal of heat and has a satisfactory running time despite the highly corrosive reaction mixture, in particular for reactors having a large number of catalyst tubes. Furthermore, the problems of hot spots should be reduced or avoided without a deliberate decrease in the catalyst activity, or only a slight gradated decrease in the activity, and without dilution of the catalyst.

One specific object of the invention is to avoid corrosion problems in the catalyst tubes in the deflection region and to make a process having a higher cross-sectional throughput and thus a higher reactor capacity possible.

The solution to this object starts out from a process for preparing chlorine by gas-phase oxidation of hydrogen chloride by means of a gas stream comprising molecular oxygen in the presence of a fixed-bed catalyst.

The process of the present invention is carried out in a reactor having a bundle of parallel catalyst tubes which are aligned in the longitudinal direction of the reactor and are fixed at their ends into tube plates, with a cap at each end of the reactor and with one or more annular deflection plates which are arranged perpendicular to the longitudinal direction of the reactor in the intermediate space between the catalyst tubes and leave circular passages free in the middle of the reactor and one or more disk-shaped deflection plates which leave annular passages free at the edge of the reactor, with an alternating arrangement of annular deflection plates and disk-shaped deflection plates with the catalyst tubes being charged with the fixed-bed catalyst, the hydrogen chloride and the gas stream comprising molecular oxygen being passed from one end of the reactor via a cap through the catalyst tubes and the gaseous reaction mixture being taken off from the opposite end of the reactor via the second cap and a liquid heat transfer medium being passed through the intermediate space around the catalyst tubes.

According to the present invention, the process is carried out in a shell-and-tube reactor having deflection plates installed between the catalyst tubes. This results in predominantly transverse flow of the heat transfer medium against the catalyst tubes and, at the same heat transfer medium flow, an increase in the flow velocity of the heat transfer medium, thus giving better removal of the heat of reaction via the heat transfer medium circulating between the catalyst tubes. This arrangement of an annular deflection plate which leaves a circular passage free in the middle of the reactor always following a disk-shaped deflection plate which leaves an annular passage free at the edge of the reactor forces a particularly favorable flow pattern of the heat transfer medium which, in particular in the case of reactors having a large number of catalyst tubes, ensures a largely uniform temperature over the cross section of the reactor.

The geometry of the deflection plates and the passages does not have to be exactly circular or annular; slight deviations do not adversely affect the result achieved according to the invention.

The disk-shaped deflection plates leaving annular passages free at the edge of the reactor means that, due to the geometric configuration of the deflection plates, passages remain free between the end of the plates and the interior wall of the reactor.

However, in a reactor which is provided with annular and disk-shaped deflection plates and which is provided with a full complement of tubes in all regions, the heat transfer medium in the region of the passages, i.e. in the deflection regions, flows largely in the longitudinal direction of the catalyst tubes. As a result, the catalyst tubes located in these deflection regions are less well cooled, so that corrosion problems can occur.

For this reason, a particularly advantageous embodiment of the process of the present invention is carried out in a shell-and-tube reactor which has no tubes in the region of the passages, i.e. in the middle of the reactor and in the region of the interior wall of the reactor.

In this embodiment, a defined, virtually purely transverse flow of the heat transfer medium against the catalyst tubes is achieved.

Owing to the flow pattern, the heat transmission coefficient on the heat transfer medium side of the catalyst tubes increases by up to 60% from the outside to the middle of the reactor cross section.

In the present case, one or more annular deflection plates are affixed to the cylindrical wall of the reactor and leave circular passages free in the middle of the reactor and disk-shaped deflection plates are fastened to a support tube and leave annular passages free at the edge of the reactor, with annular deflection plates and disk-shaped deflection plates being arranged alternately.

It has been found that leaving the interior space of the reactor free in the region of the passages, i.e. by no catalyst tubes being located in the region of the passages around the deflection plates, can increase the capacity of a reactor by a factor of from 1.3 to 2.0 compared to a reactor having a full complement of tubes and having an unchanged interior volume and an increased amount of coolant, even though a smaller total number of catalyst tubes are located in the reactor.

As liquid heat transfer medium, it can be particularly advantageous to use a salt melt, in particular a eutectic salt melt of potassium nitrate and sodium nitrite.

The deflection plates are preferably configured so that all annular deflection plates leave circular passages having the same cross-sectional area free and all disk-shaped deflection plates leave annular passages having the same area free.

To achieve very uniform flow against all catalyst tubes, it is advantageous for the liquid heat transfer medium to be introduced via a ring line located on the circumference of the reactor and be discharged via a further ring line on the circumference of the reactor, in particular for it to be passed via a lower ring line having openings through the cylindrical wall through the intermediate space around the catalyst tubes and be taken off from the reactor via openings through the cylindrical wall and an upper ring line.

The process of the present invention can in principle be carried out using all known catalysts for the oxidation of hydrogen chloride to chlorine, for example the abovementioned ruthenium-based catalysts known from DE-A 197 48 299 or DE-A 197 34 412. Further particularly useful catalysts are those described in DE 102 44 996.1, which are based on gold and comprise from 0.001 to 30% by weight of gold, from 0 to 3% by weight of one or more alkaline earth metals, from 0 to 3% by weight of one or more alkali metals, from 0 to 10% by weight of one or more rare earth metals and from 0 to 10% by weight of one or more further metals selected from the group consisting of ruthenium, palladium, platinum, osmium, iridium, silver, copper and rhenium, in each case based on the total weight of the catalyst, on a support.

The process of the present invention is in principle not restricted in terms of the source of the hydrogen chloride starting material. For example, the starting material can be a hydrogen chloride stream which is obtained as coproduct in a process for preparing isocyanates, as described in DE 102 35 476.6, the disclosure of which is hereby fully incorporated by reference into the present patent application.

In the reactor, a bundle, i.e. a large number, of parallel catalyst tubes is arranged parallel to the longitudinal direction of the reactor. The number of catalyst tubes is preferably in the range from 1000 to 40 000, in particular from 10 000 to 30 000.

Each catalyst tube preferably has a wall thickness in the range from 1.5 to 5.0 mm, in particular from 2.0 to 3.0 mm, and an internal diameter in the range from 10 to 70 mm, preferably in the range from 15 to 30 mm.

The catalyst tubes preferably have a length in the range from 1 to 10 m, more preferably from 1.5 to 8.0 m, particularly preferably from 2.0 to 7.0 m.

The catalyst tubes are preferably arranged in the interior space of the reactor in such a way that the separation ratio, i.e. the ratio of the distance between the mid points of directly adjacent catalyst tubes to the external diameter of the catalyst tubes is in the range from 1.15 to 1.6, preferably in the range from 1.2 to 1.4, and that the catalyst tubes have a triangular arrangement in the reactor.

The catalyst tubes are preferably made of pure nickel or of a nickel-based alloy.

Likewise, all further components of the reactor which come into contact with the highly corrosive reaction gas mixture are preferably made of pure nickel or a nickel-based alloy or are plated with nickel or a nickel-based alloy.

Preference is given to using Inconel 600 or Inconel 625 as nickel-based alloys. The alloys mentioned have the advantage of increased heat resistance compared to pure nickel. Inconel 600 comprises about 80% of nickel together with about 15% of chromium and iron. Inconel 625 comprises predominantly nickel, 21% of chromium, 9% of molybdenum and a few % of niobium.

The catalyst tubes are fixed in a liquid-tight manner, preferably welded, in tube plates at both ends. The tube plates preferably comprise heat-resistant carbon steel, stainless steel, for example stainless steel of the material numbers 1.4571 or 1.4541, or duplex steel (material number 1.4462) and are preferably plated with pure nickel or a nickel-based alloy on the side which comes into contact with the reaction gas. The catalyst tubes are welded to the tube plates only at the plating.

It is in principle possible to use any industrial means of applying the plating, for example roll-bonding, explosive plating, weld-cladding or strip cladding.

The internal diameter of the reactor is preferably from 1.0 to 9.0 m, particularly preferably from 2.0 to 6.0 m.

Both ends of the reactor are closed off by caps. The reaction mixture is fed to the catalyst tubes through one cap, while the product stream is taken off through the cap at the other end of the reactor.

The caps are preferably provided with gas distributors for making the gas flow uniform, for example in the form of a plate, in particular a perforated plate.

A particularly effective gas distributor is in the form of a perforated truncated cone which narrows in the direction of gas flow and whose perforations on the side surfaces have a greater open ratio, viz. about 10-12%, than the perforations on the smaller of the flat ends which project into the interior space of the reactor, viz. about 2-10%.

Since the caps and gas distributors are components of the reactor which come into contact 5 with the highly corrosive reaction gas mixture, what has been said above regarding selection of materials of construction applies, i.e. the components are made of pure nickel or a nickel-based alloy or are plated therewith.

This also applies, in particular, to pipes through which the reaction gas mixture flows or static mixers, and to the introduction devices, for example the plug-in tube.

In the intermediate space between the catalyst tubes, one or more annular deflection plates are arranged perpendicular to the longitudinal direction of the reactor so as to leave circular passages free in the middle of the reactor and one or more disk-shaped deflection plates which leave annular passages free at the edge of the reactor, with an alternating arrangement of annular deflection plates and disk-shaped deflection plates. This ensures a particularly favorable flow pattern for the heat transfer medium, especially for large reactors having a plurality of catalyst tubes. The deflection plates deflect the heat transfer medium circulating in the interior of the reactor in the intermediate space between the catalyst tubes in such a way that the heat transfer medium flows transversely against the catalyst tubes, thus improving removal of heat.

The number of deflection plates is preferably from about 1 to 15, particularly preferably. They are preferably located equidistantly from one another, but the lowermost and the uppermost deflection plate is particularly preferably at a greater distance from the respective tube plate than the distance between two successive deflection plates, preferably by a factor of up to 1.5.

The area of each passage is preferably from 2 to 40%, in particular from 5 to 20%, of the cross section of the reactor.

Both the annular and disk-shaped deflection plates are preferably not sealed around the catalyst tubes and allow a leakage flow of up to 30% by volume of the total flow of the heat transfer medium. For this purpose, gaps in the range from 0.1 to 0.4 mm, preferably from 0.15 to 0.30 mm, are permitted between the catalyst tubes and the deflection plates. To make heat removal even more uniform over all catalyst tubes over the cross section of the reactor, it is particularly advantageous for the gap between the catalyst tubes and the annular deflection plates to increase, preferably continuously from the outside inward, i.e. from the wall of the reactor to the middle of the reactor.

It is advantageous for the annular deflection plates to be sealed in a liquid-tight manner against the interior wall of the reactor, so that no additional leakage flow occurs directly at the cylindrical wall of the reactors.

The deflection plates can be made of the same material as the tube plates, i.e. of heat-resistant carbon steel, stainless steel having the material numbers 1.4571 or 1.4541 or duplex steel (material number 1.4462), preferably in a thickness of from 6 to 30 mm, preferably from 10 to 20 mm.

The catalyst tubes are charged with a solid catalyst. The catalyst bed in the catalyst tubes preferably has a gap volume of from 0.15 to 0.65, in particular from 0.20 to 0.45.

The region of the catalyst tubes at the end at which the gaseous reaction mixture is fed in is particularly preferably filled with an inert material to a length of from 5 to 20%, preferably a length of from 5 to 10%, of the total length of the catalyst tubes.

To compensate for thermal expansion, one or more compensators installed in the form of an annulus at the reactor wall are advantageously provided on the reactor wall.

The process is in principle not restricted in terms of the flow directions of the reaction gas mixture and the heat transfer medium, i.e. both can be passed through the reactor from the top downward or from the bottom upward independently of one another. Any combination of flow directions of reaction gas mixture and heat transfer medium is possible. It is possible for example to pass the gaseous reaction mixture and the liquid heat transfer medium through the reactor in cross-countercurrent or in cross-cocurrent.

The temperature profile over the course of the reaction can be addressed particularly well when the process is carried out in a reactor having two or more reaction zones. It is likewise possible to carry out the process in two or more separate reactors instead of a single reactor having two or more reaction zones.

If the process is carried out in two or more reaction zones, the internal diameter of the catalyst tubes is preferably different in different reactors. In particular, reactors in which reaction stages which are particularly endangered by hot spots can be provided with catalyst tubes having a smaller internal diameter compared to the remaining reactors. This ensures improved removal of heat in these particularly endangered regions.

In addition or as an alternative, it is also possible to have two or more reactors connected in parallel in the reaction stage endangered by hot spots, with the reaction mixture subsequently being combined via one reactor.

If a reactor is divided into a plurality of zones, preferably from 2 to 8, particularly preferably from 2 to 6, reaction zones, these are separated from one another in a largely liquid-tight manner by means of separating plates. For the present purposes, “largely” means that complete separation is not absolutely necessary but manufacturing tolerances are permitted.

Thus, the zones can be largely separated from one another by the separating plate having a relatively great thickness of from about 15 to 60 mm, with a fine gap between the catalyst tube and the separating plate of about 0.1-0.25 mm being permitted. In this way, it is possible, in particular, for the catalyst tubes to be replaced in a simple manner if necessary.

In a preferred embodiment, the seal between the catalyst tubes and the separating plates can be improved by the catalyst tubes being slightly rolled on or hydraulically widened.

Since the separating plates do not come into contact with the corrosive reaction mixture, the selection of materials for the separating plates is not critical. For example, they can be made of the same material as is used for the plated part of the tube plates, i.e. heat-resistant carbon steel, stainless steel, for example stainless steel having the material numbers 1.4571 or 1.4541 or duplex steel (material number 1.4462).

Ventilation or drainage holes for the heat transfer medium are preferably provided in the reactor wall and/or in the tube plates and/or in the separating plates, in particular at a plurality of points, preferably from 2 to 4 points, arranged symmetrically over the reactor cross section which open outward, preferably into half shells welded onto the outer wall of the reactor or onto the tube plates outside the reactor.

In the case of a reactor having two or more reaction zones, it is advantageous for each reaction zone to have at least one compensator to compensate thermal stresses.

In the process variant in which a plurality of reactors is employed, intermediate introduction of oxygen is advantageous, preferably via a perforated plate in the lower reactor cap which ensures more uniform distribution. The perforated plate preferably has a degree of perforation of from 0.5 to 5%. Since it is in direct contact with the highly corrosive reaction mixture, it is preferably manufactured of nickel or a nickel-based alloy.

In the case of an embodiment having two or more reactors located directly above one another, i.e. in a particularly space-saving construction variant, with omission of the lower cap of each higher reactor and the upper cap of each reactor underneath it, the intermediate introduction of oxygen can be carried out between two reactors arranged directly above one another via a half shell welded onto the outside through uniformly distributed holes over the outer wall of the reactor.

Static mixers are preferably installed between the individual reactors after the intermediate introduction of oxygen.

As regards the choice of materials of construction for the static mixers, what has been said above in general terms for the components which come into contact with the reaction gas mixture applies, i.e. pure nickel or nickel-based alloys are preferred.

In a process in which a plurality of reactors are employed, intermediate introduction of oxygen can be carried out via a perforated, preferably curved, plug-in tube which opens into the connecting tube between two reactors.

The invention is illustrated below with the aid of a drawing.

In the figures, identical reference numerals denote identical or corresponding features.

In the drawing:

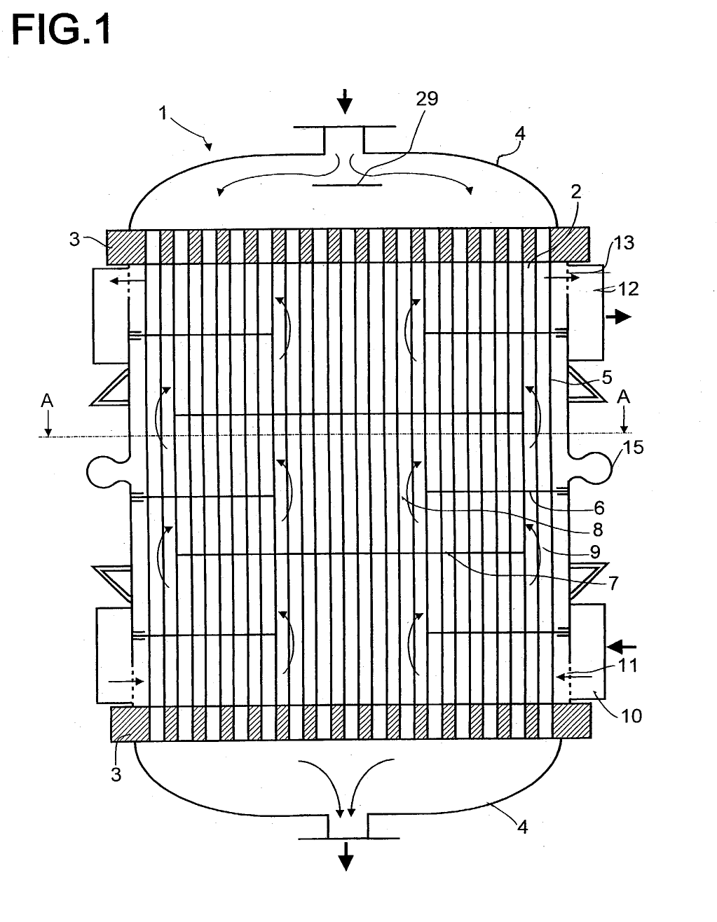

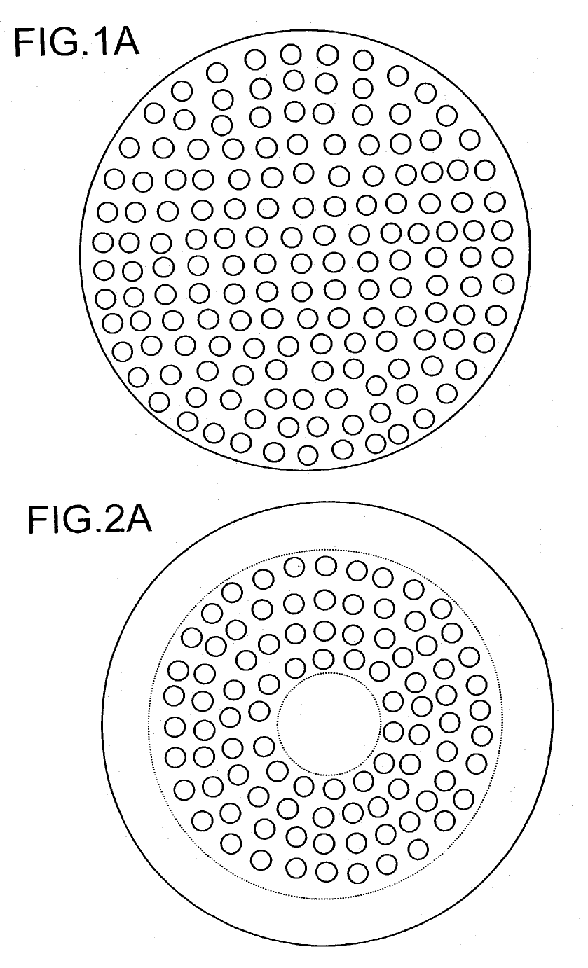

FIG. 1 shows a first preferred embodiment of a reactor for the process of the present invention in longitudinal section with cross-countercurrent flow of reaction mixture and heat transfer medium, with cross-sectional view in FIG. 1A,

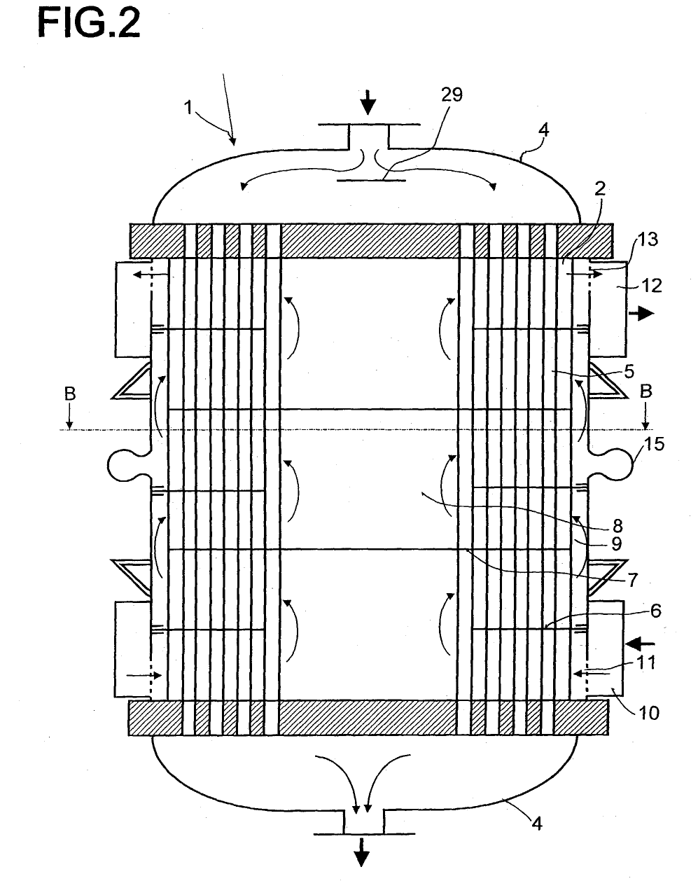

FIG. 2 shows a preferred embodiment of a reactor in longitudinal section, with cross-countercurrent flow of reaction mixture and heat transfer medium, with no tubes being present in the reactor in the region of the passages, with cross-sectional view in FIG. 2A,

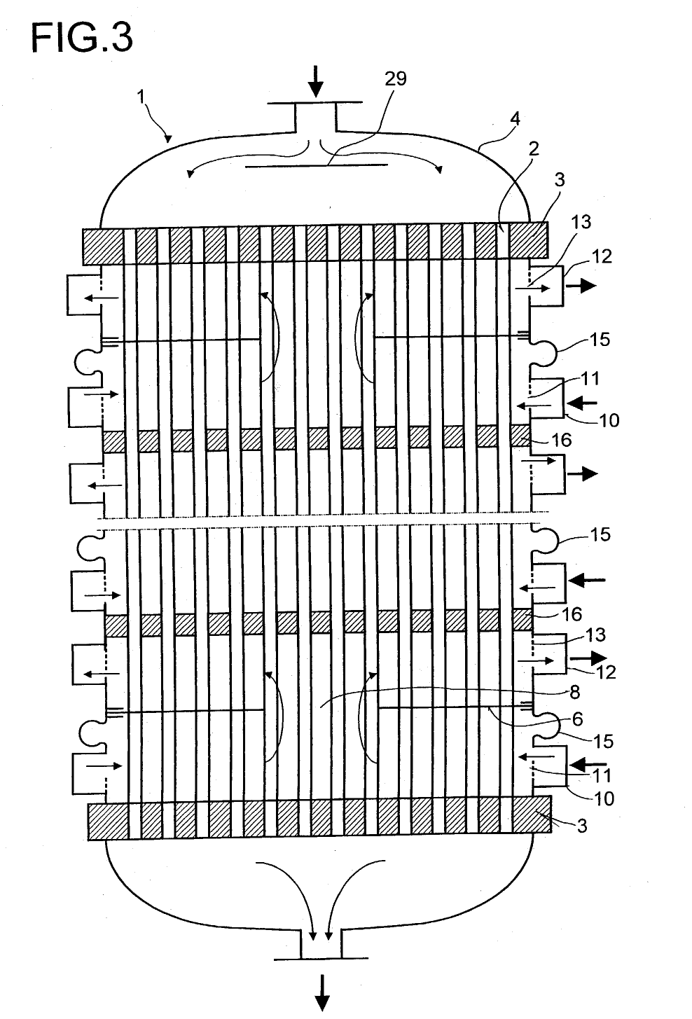

FIG. 3 shows a firther embodiment of a multizone reactor,

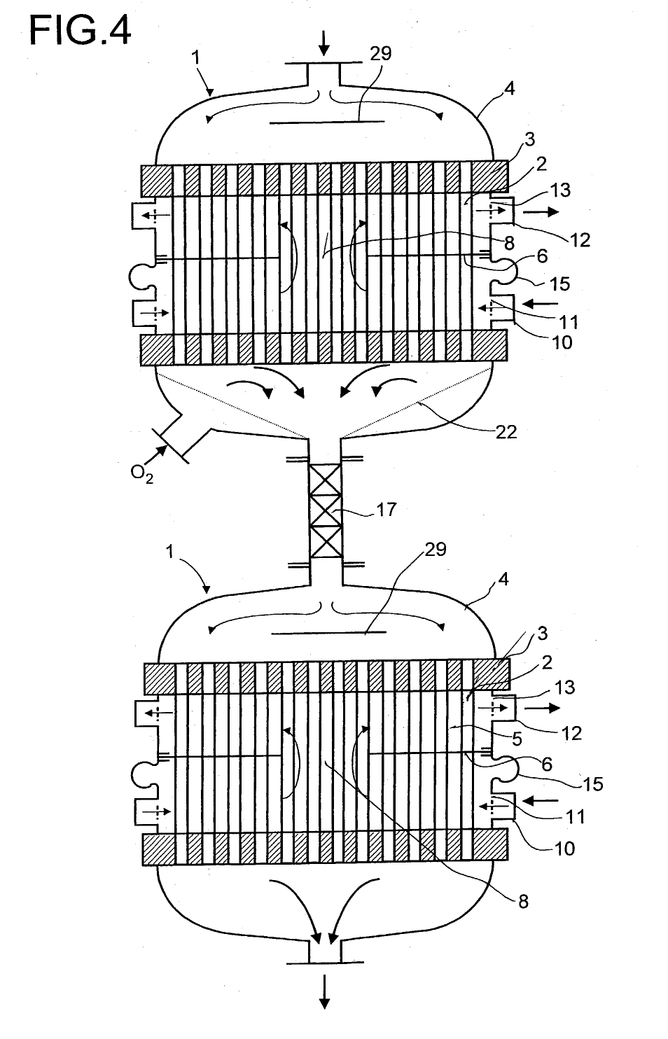

FIG. 4 shows an embodiment having two reactors connected in series,

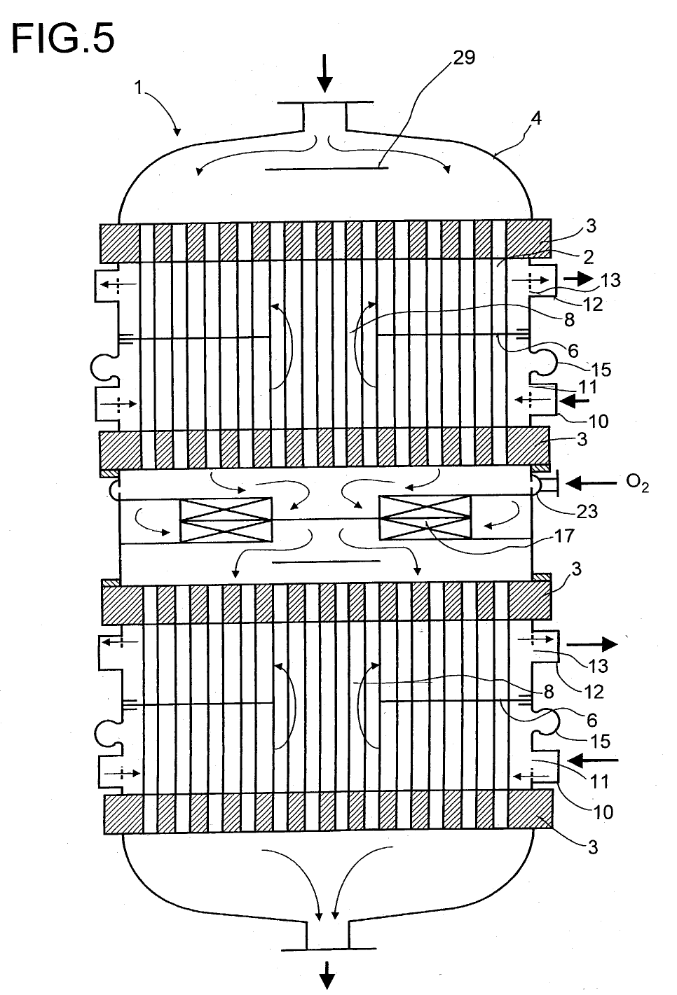

FIG. 5 shows an embodiment having two compactly arranged reactors with static mixers between the reactors,

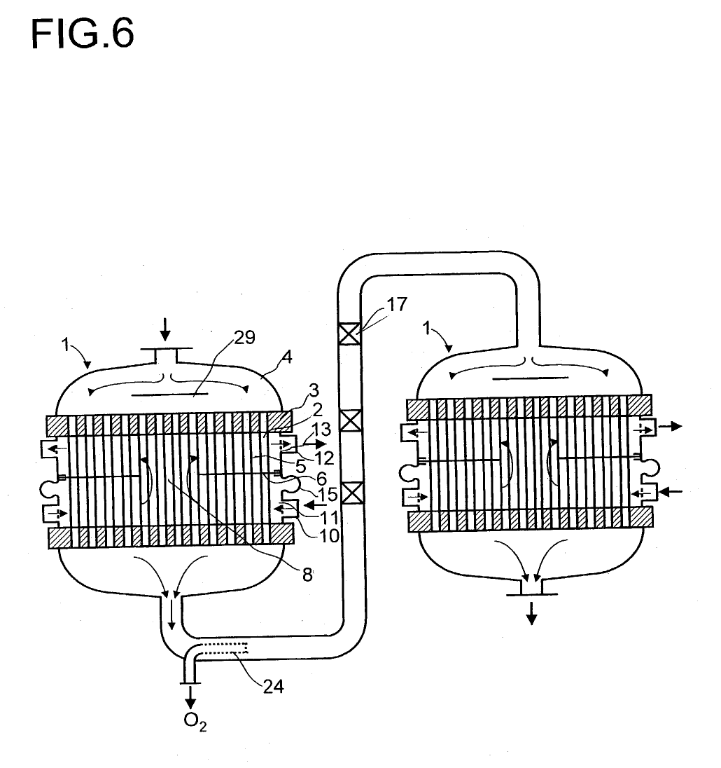

FIG. 6 shows an embodiment having two reactors connected in series,

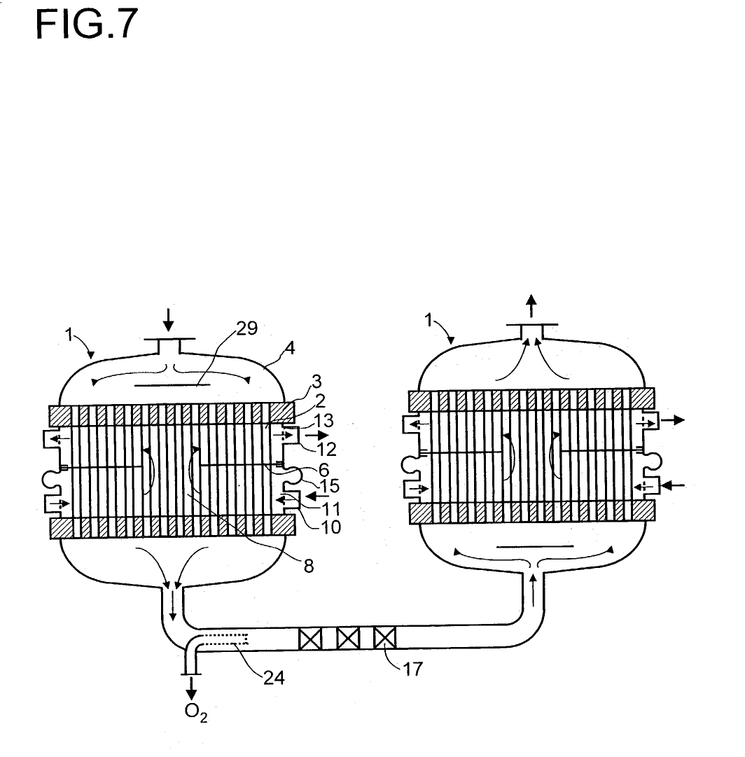

FIG. 7 shows a further embodiment having reactors through which the reaction mixture flows from the top downward,

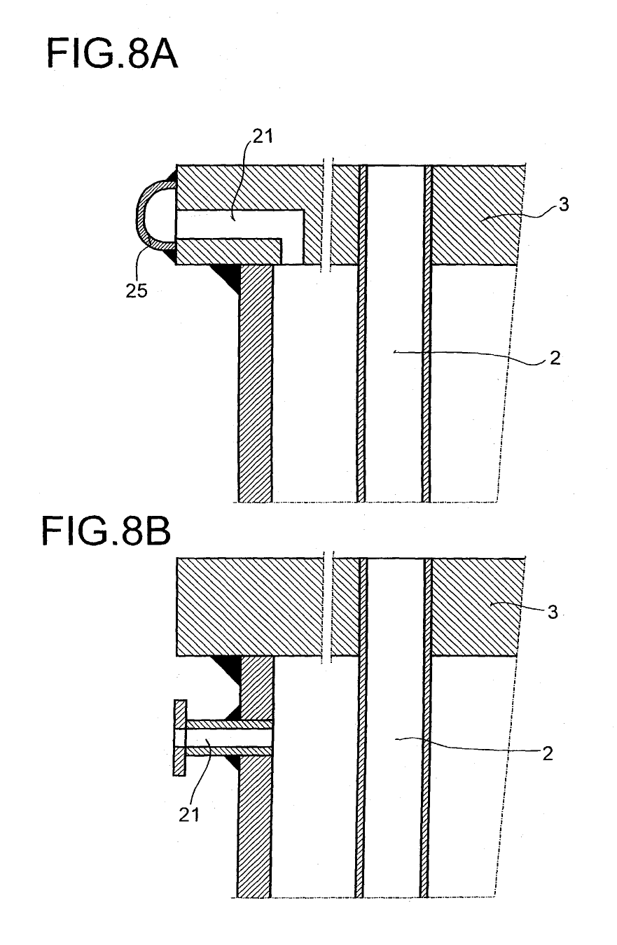

FIG. 8A shows an angled ventilation hole in the tube plate,

FIG. 8B shows a ventilation hole in the wall of the reactor,

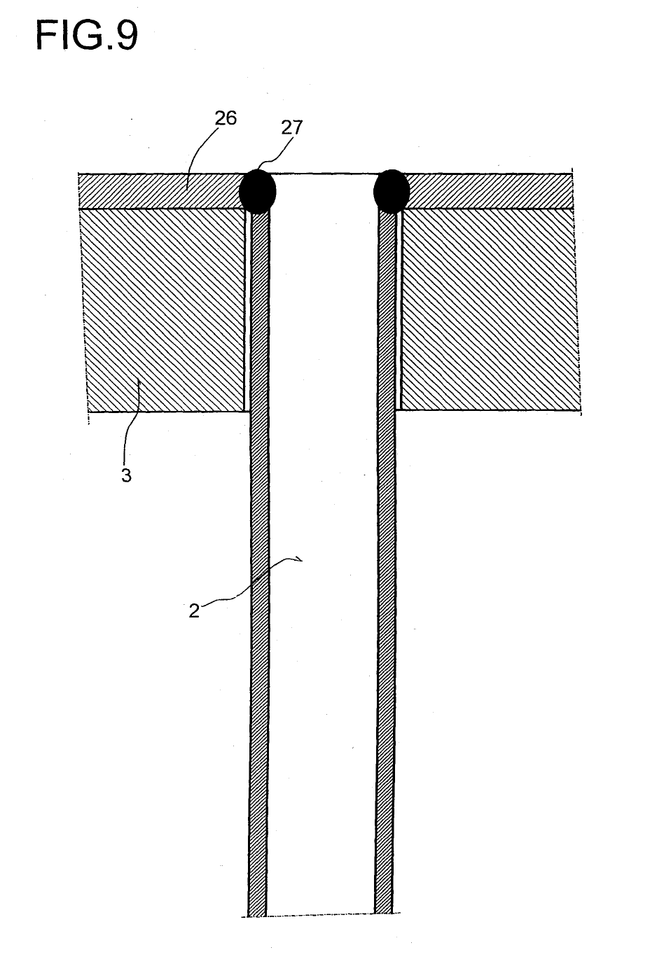

FIG. 9 shows a connection of the catalyst tubes with the plating of the tube plate and

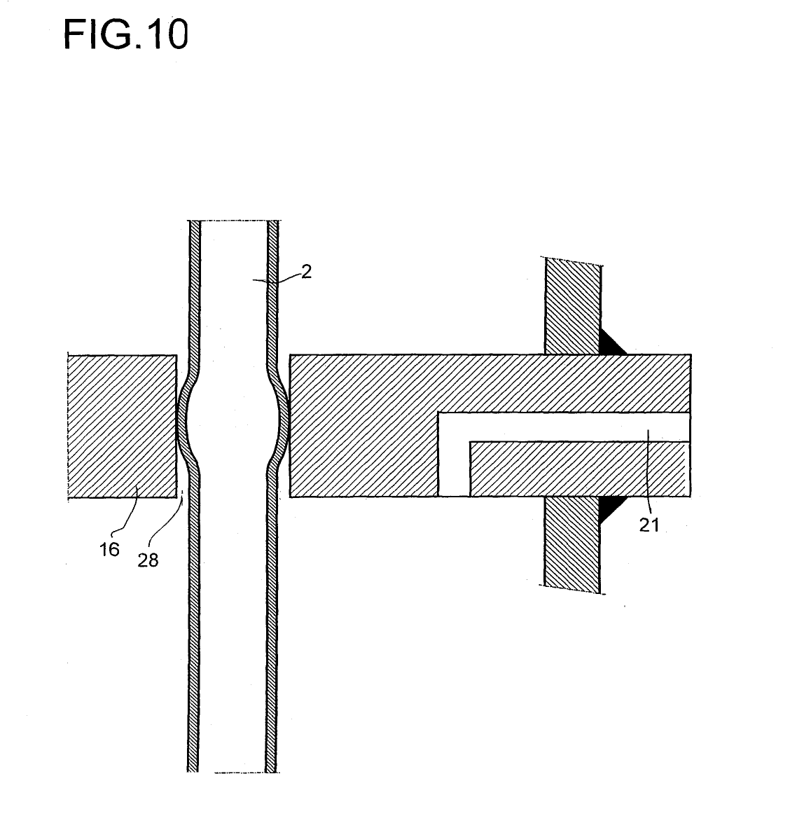

FIG. 10 shows a connection between catalyst tube and separating plate.

FIG. 1 shows a first embodiment of a reactor 1 for the process according to the invention, in longitudinal section, with catalyst tubes 2 fixed inside tube plates 3.

Both ends of the reactor are closed off from the outside by caps 4. The reaction mixture is fed through one cap to the catalyst tubes 2, while the product stream is taken off through the cap at the other end of the reactor 1. Gas distributors for making the gas flow more uniform, for example in the form of a plate 29, in particular a perforated plate, are preferably arranged in the caps.

In the intermediate space between the catalyst tubes 2 there are annular deflection plates 6 which leave circular passages 9 free in the middle of the reactor and disk-shaped deflection plates 7 which leave annular passages 9 free at the reactor wall. The liquid heat transfer medium is introduced via the outer ring line 10 and openings 11 in the wall into the intermediate space between the catalyst tubes 2 and is taken off from the reactor via the openings 13 in the wall and the upper ring line 12. An annular compensator 15 is provided on the cylindrical wall of the reactor.

The further embodiment shown in FIG. 2, likewise in longitudinal section, differs from the previous embodiment in that, in particular, the interior space of the reactor is free of catalyst tubes in the region of the circular passages 8 and the annular passages 9 for the heat transfer medium.

The embodiment shown in longitudinal section in FIG. 3 depicts a multizone, for example three-zone, reactor whose individual reaction zones are separated from one another by dividing plates 16.

The embodiment in FIG. 4 shows two reactors 1 located vertically above one another with a static mixer 17 in the connecting pipe between the two reactors 1. Perforated plates 22 are provided in the lower cap of the upper reactor 1 to make the flow of the oxygen stream O₂ introduced between the reactors below the perforated plate 22 more uniform.

FIG. 5 shows a further embodiment with, by way of example, two reactors 1 arranged compactly one above the other, with the lower cap of the upper reactor 1 and the upper cap of the lower reactor 1 having been dispensed with to save space. Intermediate introduction of oxygen (O₂) in the region between the two reactors is provided via a half shell 23 welded onto the outer circumference of the reactor. A static mixer 17 is located downstream of the intermediate introduction of oxygen.

The embodiment in FIG. 6 shows two reactors 1 connected in series, with intermediate introduction of oxygen via a perforated plug-in tube 24 which opens into the connecting pipe between the two reactors, and with static mixers 17 in the connecting pipe between the two reactors.

The embodiment depicted in FIG. 7 differs from the embodiment in FIG. 6 in that the reaction mixture flows through both reactors from the top downward and through the second reactor from the bottom upward.

The enlarged view in FIG. 8A shows an angled ventilation hole 21 in the tube plate 3, with half shell 25 over the ventilation hole 21.

The enlarged view in FIG. 8B shows a further variant of a ventilation hole 21, here on the outer wall of the reactor.

The enlarged view in FIG. 9 shows the connection of the catalyst tubes 2 with the plating 26 of the tube plate 3 in the form of a weld 27.

The enlarged view in FIG. 10 shows the narrowing of the gap 28 between a catalyst tube 2 and the separating plate 16 by the catalyst tube 2 being rolled onto the separating plate 16 and an angled ventilation hole 21 in the separating plate 16.

List of reference numerals

| 1 | Reactor | | |
|---|---|---|---|
| 2 | Catalyst tubes | | |
| 3 | Tube plates | | |
| 4 | Caps | | |
| 5 | Intermediate space between catalyst tubes | | |
| 6 | Annular | | |
| | | {close oversize brace} | deflection plates |
| 7 | Disk-shaped | | |
| 8 | Circular | | |
| | | {close oversize brace} | passages |
| 9 | Annular | | |

| | |
|---|---|
| 10 | Lower ring line |
| 11 | Openings through the wall in the lower ring |
| | line |
| 12 | Upper ring line |
| 13 | Openings through the wall in the upper ring |
| | line |
| 14 | Gap between catalyst tubes (2) and |
| | deflection plates (6,7) |
| 15 | Compensator |
| 16 | Separating plates |
| 17 | Static mixers |
| 18 | Pump for heat transfer medium |
| 19 | Cooler for heat transfer medium |
| 21 | Ventilation holes |
| 22 | Perforated plates |
| 23 | Half shell |
| 24 | Plug-in tube |
| 25 | Half shell over ventilation hole |
| 26 | Plating |
| 27 | Weld seam |
| 28 | Gap between catalyst tube and separating plate |
| 29 | Impingement plate |
| O₂ | Intermediate introduction of oxygen |

We claim:

1. A process for preparing chlorine by gas-phase oxidation of hydrogen chloride by means of a gas stream comprising molecular oxygen in the presence of a fixed-bed catalyst, which is carried out in a reactor having a bundle of parallel catalyst tubes which are aligned in the longitudinal direction of the reactor and are fixed at their ends into tube plates, with a cap at each end of the reactor and with one or more annular deflection plates which are arranged perpendicular to the longitudinal direction of the reactor in the intermediate space between the catalyst tubes and leave circular passages free in the middle of the reactor and one or more disk-shaped deflection plates which leave annular passages free at the edge of the reactor, with an alternating arrangement of annular deflection plates and disk-shaped deflection plates with the catalyst tubes being charged with the fixed-bed catalyst, the hydrogen chloride and the gas stream comprising molecular oxygen being passed from one end of the reactor via a cap through the catalyst tubes and the gaseous reaction mixture being taken off from the opposite end of the reactor via the second cap and a liquid heat transfer medium being passed through the intermediate space around the catalyst tubes.

2. A process as claimed in claim 1, wherein the liquid heat transfer medium is passed via a lower ring line having openings through the cylindrical wall through the intermediate space around the catalyst tubes and is taken off via openings in the cylindrical wall and an upper ring line.

3. A process as claimed in claim 1 carried out in a reactor which has no tubes in the region of the passages.

4. A process as claimed in claim 1, wherein the process is carried out in a reactor in which all annular deflection plates leave circular passages having the same cross-sectional area free and all disk-shaped deflection plates leave annular openings having the same area free.

5. A process as claimed in claim 1 carried out in a reactor in which the area of each passage is from 2 to 40% of the cross section of the reactor.

6. A process as claimed in claim 5, in which the area is from 5 to 20% of the cross section of the reactor.

7. A process as claimed in claim 1 carried out in a reactor having from 1000 to 40 000 catalyst tubes.

8. A process as claimed in claim 7, in which the reactor has from 10 000 to 30 000 catalyst tubes.

9. A process as claimed in claim 1 carried out in a reactor in which each catalyst tube has a length in the range from 1 to 10 m.

10. A process as claimed in claim 9, in which the length is in the range from 1.5 to 8.0 m.

11. A process as claimed in claim 10, in which the length is in the range from 2.0 to 7.0 m.

12. A process as claimed in claim 1 carried out in a reactor in which each catalyst tube has a wall thickness in the range from 1.5 to 5.0 mm and an internal diameter in the range from 10 to 70 mm.

13. A process as claimed in claim 1, in which the wall thickness is in the range from 2.0 to 3.0 mm and an internal diameter in the range from 15 to 30 mm.

14. A process as claimed in claim 1 carried out in a reactor whose catalyst tubes are arranged in the interior space of the reactor in such a way that the separation ratio, i.e. the ratio of the distance between the midpoints of directly adjacent catalyst tubes to the external diameter of the catalyst tubes is in the range from 1.15 to 1.6 with the catalyst tubes preferably being present in a triangular arrangement.

15. A process as claimed in claim 14, in which the separation ratio is in the range from 1.2 to 1.4.

16. A process as claimed in claim 1 carried out in a reactor in which gaps of from 0.1 to 0.4 mm are present between the catalyst tubes and the deflection plates.

17. A process as claimed in claim 16 in which gaps of from 0.15 to 0.30 mm are present.

18. A process as claimed in claim 16 with the gaps between the catalyst tubes and the annular deflection plates being increasing from the outside inward.

19. A process as claimed in claim 18, in which the gaps increase continuously.

20. A process as claimed in claim 1, wherein the annular deflection plates are fixed in a liquid-tight manner to the interior wall of the reactor.

21. A process as claimed in claim 1 carried out in a reactor whose deflection plates have a thickness in the range from 6 to 30 mm.

22. A process as claimed in claim 21, in which the thickness is in the range from 10 to 20 mm.

23. A process as claimed in claim 1 carried out in a reactor having one or more compensators in its outer wall.

24. A process as claimed in claim 1, wherein the gaseous reaction mixture and the liquid heat transfer medium are passed through the reactor in cross-countercurrent or in cross-cocurrent.

25. A process as claimed in claim 1, wherein the region of the catalyst tubes nearest the end at which the gaseous reaction mixture is fed in is filled with an inert material to a length of from 5 to 20% of the total length of the catalyst tubes.

26. A process as claimed in claim 25, wherein the region is filled to a length of from 5 to 10%.

27. A process as claimed in claim 1, wherein all components of the reactor which come into contact with the reaction gas are made of pure nickel or a nickel-based alloy.

28. A process as claimed in claim 1, wherein all components of the reactor which come into contact with the reaction gas are plated with pure nickel or a nickel-based alloy.

29. A process as claimed in claim 1, wherein the catalyst tubes are made of pure nickel or a nickel-based alloy and the tube plates are plated with pure nickel or a nickel-based alloy and the catalyst tubes are welded to the tube plates only at the plating.

30. A process as claimed in claim 1, wherein the reactor has at least two reaction zones which are separated in a largely liquid-tight manner by means of dividing plates.

31. A process as claimed in claim 30, wherein the at least two reaction zones are separated by rolling of the catalyst tubes onto the dividing plates.

32. A process as claimed in claim 1 carried out in at least two reactors.

33. A process as claimed in claim 32, wherein the internal diameter of the catalyst tubes differs from one reactor to another.

34. A process as claimed in claim 33, in which the reactors in which part reactions occur which are particularly at risk from hot spots have catalyst tubes having a smaller internal diameter compared to the other reactors.

35. A process as claimed in claim 32, wherein static mixers are installed between the reactors.

36. A process as claimed in claim 1, wherein ventilation holes for the heat transfer medium are provided in at least one means selected from the group outer wall of the reactor, the tube plates and dividing plates.
